(19) United States
(12) Patent Application Publication
(10) Pub. No.: US 2005/0269213 A1
(43) Pub. Date: Dec. 8, 2005

(54) Electrochemical Corrosion Monitoring Device and Method

(75) Inventors: Eric T Steimle, St. Petersburg, FL (US); George T. Steimle, St. Petersburg, FL (US); Scott Samson, Safety Harbor, FL (US); Stanislav Ivanov, St. Petersburg, FL (US)

Correspondence Address: SMITH & HOPEN PA, 15950 BAY VISTA DRIVE, SUITE 220, CLEARWATER, FL, 33760, US

(73) Assignee: UNIVERSITY OF SOUTH FLORIDA, Tampa, FL (US)

(21) Appl. No.: 11/160,085

(22) Filed: Jun. 8, 2005

Related U.S. Application Data
(63) Continuation of application No. 60/521,629, filed on Jun. 8, 2004.

(51) Int. Cl. G01N 27/26

(52) U.S. Cl. 205/775.5; 204/404

(57) ABSTRACT

According to the present invention a corrosion sensor is provided to detect and quantify the level of corrosion present in an electrical component. The corrosion monitor of the present invention includes at least one resistive element exposed to the electrical component and at least two bond pads from which to measure the change in resistance due to corrosion of the electrical component.

### CROSS-REFERENCE TO RELATED APPLICATIONS

This disclosure claims priority from U.S. provisional application Ser. No. 60/521,629 filed by the same inventors on Jun. 8, 2004.

### BACKGROUND OF INVENTION

Corrosion is a common electrochemical process. The effects of corrosion in a variety of commercial, military and household products results in replacement costs exceeding cost of billions of dollars to consumers. Often, severe or even minor corrosion can result in a malfunctioning product. Depending on the product affected, consequences can range from minor inconvenience, to potentially life-threatening conditions. Studies in a number of countries have attempted to determine the national cost of corrosion. In 1976, the United States conducted a study which determined that the overall annual cost of metallic corrosion to the U.S. economy was $70 billion.

In recent years, there has seen an increasing use of metal prosthetic devices in the body, such as pins, plates, hip joints, pacemakers, and other implants. New alloys and better techniques of implantation have been developed, but corrosion continues to create problems. Potential critical areas of corrosion in the health industry include failures through broken connections in pacemakers, inflammation caused by corrosion products in the tissue around implants, and fracture of weight-bearing prosthetic devices. In addition to corrosion issues evident in the health industry, an even more significant problem is the corrosion of structures, which can result in severe injuries or even loss of life. Corrosion effects contributing to the failure of bridges, aircraft, automobiles and gas pipelines create safety concerns for the public.

Periodic inspection of critical components is one method to determine the severity of corrosion that has occurred to the components over time. However, this method is costly and may not even be possible if a corroded component is hidden deep inside a complex instrument or system. As a result, system components are often replaced at fixed maintenance intervals, often before the actual need arises.

What is needed in the art is a method and apparatus to detect and quantify corrosion that is practical, inexpensive, and adaptable for use in a variety of systems comprising electronic components.

### SUMMARY OF INVENTION

In accordance with the present invention is an electrochemical corrosion measuring and monitoring device adapted to detect and quantify the level of corrosion present in an electrical component. The present invention provides a compact electrical corrosion sensor with facility for rapid fabrication.

In a particular embodiment of the present invention, a device to measure the corrosion experienced by an electrical component in a potentially corrosive environment is provided. The device including at least one resistive element positioned proximate to the electrical component, the resistive element having an anode and a cathode, means for supplying a differential voltage between the anode and the cathode and means for measuring the corrosion-induced resistance of the at least one resistive element between the anode and the cathode.

In an additional embodiment, bond pads may be used to contact the anode and the cathode of the resistive element and the bond pads may be isolated from the corrosive environment to provide a consistent contact for the application of the probing voltage that is not effective by the corrosion experienced by the resistive element. With this embodiment, a first bond pad is electrically connected to the resistive element at the anode and a second bond pad is electrically connected to the resistive element at the cathode and the first bond pad and the second bond pad are isolated from the potentially corrosive environment. The bond pads may be isolated by the application of a protective coating, or they may be physically isolated from the corrosive environment while still maintaining electrical connectivity to the anode and the cathode of the resistive element.

As such, the present invention provides a method for measuring the corrosion experienced by an electrical component in a potentially corrosive environment. The method include the steps of, placing at least one resistive element proximate to the electrical component for which corrosion is to be measured, supplying a differential voltage across the resistive element, measuring the corrosion-induced resistance of the at least one resistive element and relating the measured corrosion-induced resistance to the corrosion experienced by the electrical component.

When the corrosion monitoring device in accordance with the present invention is placed in the proximity of an electrical component in a potentially corrosive environment, the device provides continuous and instantaneous feedback regarding the status of the critical electrical component, thereby increasing the safety of the device. The corrosion monitor of the present invention addresses electronic system integrity of highly sensitive components during storage and while in the field under harsh environmental conditions. The invention can be used with all devices susceptible to corrosion, including Micro Electro Mechanical Systems (MEMS) devices.

In accordance with one embodiment of the present invention, a miniature electronic corrosion sensor is provided. The sensor monitors the corrosiveness of the environment that a printed circuit board (PCB) has experienced. The sensor is customizable through the configuration of the circuit, the amount and type of material used for the sensing region and the PCB integration. Placing the device in close proximity to a sensitive component will allow for continuous monitoring of the amount of corrosion the device has experienced. When a MEMs device is the target item, the sensor may be built directly into the MEMs circuit.

The corrosion monitor of the present invention provides many benefits over other methods known in the art to measure and monitor corrosion. The monitor is extremely low cost and disposable and is capable of detecting corrosion in a wide variety of environments. The present invention measures the effect of corrosion irregardless of the source, including, but not limited to atmospheric, chemical, salt spray, nitrates, sulfites and sulfates. Additionally, the monitor can be incorporated into the electronic manufacturing process of the critical system to allow for the measurement and monitoring of electrical components within the system that are inaccessible when employed in the field.

### BRIEF DESCRIPTION OF THE DRAWINGS

For a fuller understanding of the invention, reference should be made to the following detailed description, taken in connection with the accompanying drawings, in which:

FIG. 1 is an illustrative example of the electrochemical corrosion monitor in accordance with the present invention employing a serpentine circuit for electrical corrosion detection.

FIG. 2 is an illustrative example of the electrochemical corrosion monitor wherein the serpentine circuit forms a Wheatstone Bridge in accordance with the present invention. This configuration enables higher sensitivity to small variations in corrosion-induced resistivity.

FIG. 3 depicts a partial bridge including only two series resistive elements.

### DETAILED DESCRIPTION OF THE PREFERRED EMBODIMENT

In the following detailed description of the preferred embodiments, reference is made to the accompanying drawings, which form a part hereof, and within which are shown by way of illustration specific embodiments by which the invention may be practices. It is to be understood that other embodiments may be utilized and structural changes may be made without departing from the scope of the invention.

The principle of operation of the corrosion sensor in accordance with the present invention is the change in electrical resistivity that occurs as a result of corrosion. Typically, a metal, such as iron, aluminum, copper, etc. forms an oxide. Such oxides have higher resistivity compared to the bare unoxidized metal. Thus, if a metal is deposited, machined, or formed into an electrode structure such that electrical connections may be made to the metal, the resistivity can be precisely measured. Upon exposure to the corrosive or potentially corrosive environment, the degree of corrosion can be determined from the change in resistivity of the device. The change in resistivity is referred to as the corrosion-induced resistivity. Accordingly, when it is desired to measure and monitor the corrosion experienced by a critical electrical component, the corrosion sensor in accordance with the present invention is placed in close proximity to the critical component and the corrosion-induced resistivity experienced by the corrosion monitor is representative of the corrosion experienced by the critical component.

The corrosion sensor in accordance with the present invention can be mass fabricated using standard thin film deposition and photolithographic patterning techniques; hence, the size can be miniaturized. This miniaturization and amenability to mass fabrication allows for a low cost solution.

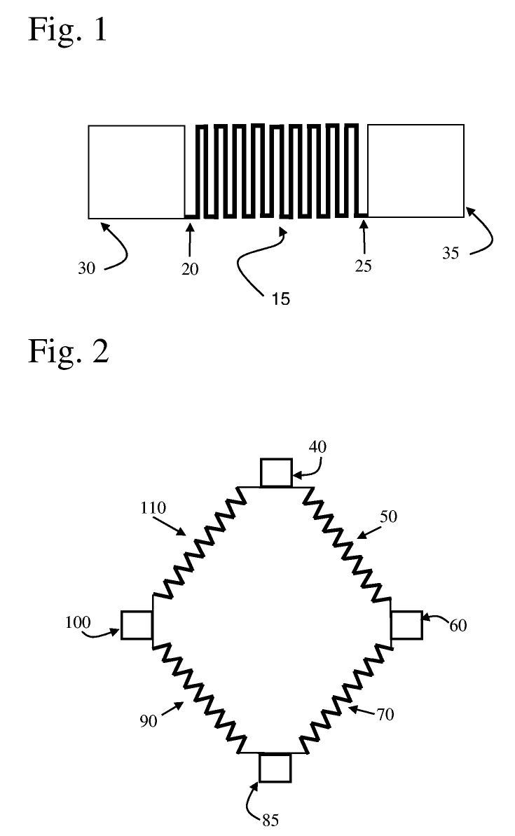

The corrosion sensor in accordance with one embodiment of the present invention is a thin-film deposited and lithographically defined resistor. As shown with reference to FIG. 1, a simple resistor 15, having a serpentine form added to increase the length of the resistor for a given surface area, is illustrated. It is understood that one can envision other shapes, including a straight line, to make up the resistor unit. The dimensions of the resistor section 15 can be varied according to the sensitivity required and electrical properties of the metal. The resistive unit includes an anode 20 at one end and a cathode 25 at the opposite end. Bondpads 30, 35, where electrical connection to the metal can be made, are included on the ends of the electrode.

In a specific embodiment, the serpentine electrode 15 is exposed to the corrosive environment, a voltage is applied between the anode 20 and the cathode 25, utilizing the bond pads 30, 35, and the resulting corrosion-induced resistivity is determined based upon the current flow through the resistive element. It is understood that one can apply a current through the device and the corrosion-induced resistivity can be determined based upon the induced voltage between the anode 20 and the cathode 25.

In an additional embodiment, the anode bond pad 30 and the cathode bond pad 35 may be optionally coated with a protective material so that the conductive bond pads are not exposed to the corrosive environment. Such coatings are typically used in the electronics industry and are generally conformal in nature. This coating may be made of epoxy, polyimide, or any number of polymeric or protective coatings known to those familiar with the state-of-the-art.

In an additional embodiment, the bond pads may be physically isolated from the resistive element, such as being placed on the opposite side of the printed circuit board to protect the conductive bond pads from the corrosive environment.

If small changes in resistance need to be measured, or thermal compensation is required, the linear resistor can be fabricated in a so-called Wheatstone bridge configuration, as shown in FIG. 2. The Wheatstone bridge configuration is known in the art. In this embodiment, two opposite bond pads, a top bond pad 40 and a bottom bond pad 85, are used to apply a probing voltage to the Wheatstone bridge device. Upon application of the probing voltage, the voltage difference between the other two bond pads, the left bond pad 100 and the right bond pad 60, can be measured. In a particular embodiment, only one resistive element of the bridge, e.g. the upper left element 110, is exposed to the corrosive environment, the resistance of this element changes as corrosion occurs and the corrosion-induced resistance can be measured and monitored. The other three electrodes 90, 70 and 50 may be protected, as described above, using conformal coatings. The benefit of utilizing a Wheatstone bridge configuration is that variation in all the electrodes' resistance, such as due to temperature changes, occur in each of the four electrodes simultaneously, and thus the differential sensing voltage does not change. Additionally, if 2× sensitivity is desired, opposite resistive elements, such as the upper left 110 and lower right 70, may be exposed to the corrosive environment, while the other two resistive elements 90 and 50 are protected from the environment.

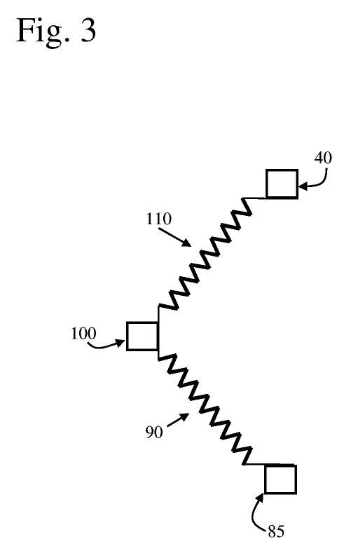

With reference to FIG. 3, in an additional embodiment, partial bridges comprising only two series resistive elements. In accordance with this embodiment, the top bond pad 40 and bottom pad 85, are used to apply a probing voltage to the device. Upon application of the probing voltage, the voltage difference variation at the other bond pad 100 can be measured. In a particular embodiment, only one resistive element of the pair, e.g. the upper element 110, is exposed to the corrosive environment. The resistance of this element 110 changes as corrosion occurs and the corrosion-induced resistance can be measured and monitored. The other electrode 90 may be protected, as described above, using conformal coatings.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween. Now that the invention has been described,

1. A device to measure the corrosion experienced by an electrical component in a potentially corrosive environment, the device comprising:
at least one resistive element positioned proximate to the electrical component, the at least one resistive element having an anode and a cathode;
means for establishing a voltage differential between the anode and the cathode; and
means for measuring the corrosion-induced resistance of the at least one resistive element between the anode and the cathode.

2. The device of claim 1, further comprising a first bond pad electrically connected to the resistive element at the anode and a second bond pad electrically connected to the resistive element at the cathode, the first bond pad and the second bond pad isolated from the potentially corrosive environment.

3. The device of claim 2, wherein the first bond pad and the second bond pad are isolated from the corrosive environment by the application of a protective coating.

4. The device of claim 2, wherein the first bond pad and the second bond pad are physically isolated from the corrosive environment.

5. The device of claim 1, wherein the means for establishing a voltage differential between the anode and the cathode further comprises means for supplying a differential voltage between the anode and the cathode.

6. The device of claim 1, wherein the means for establishing a voltage differential between the anode and the cathode further comprises means for supplying a current through the resistive element.

7. The device of claim 1, wherein the at least one resistive element is a serpentine resistor.

8. The device of claim 1, wherein the at least one resistive element is in a Wheatstone bridge.

9. The device of claim 8, wherein the Wheatstone bridge further comprises:
four resistive elements connected in a series-parallel bridge configuration;
at least one of the four resistive elements positioned in the potentially corrosive environment;
means for establishing a voltage differential across the parallel resistive elements; and
means for measuring the corrosion-induced resistance of the at least one of the four resistive elements positioned in the potentially corrosive environment.

10. The device of claim 9, wherein the means for establishing a voltage differential between the anode and the cathode further comprises means for supplying a differential voltage between the anode and the cathode.

11. The device of claim 1, wherein the means for establishing a voltage differential between the anode and the cathode further comprises means for supplying a current through the resistive element.

12. A method for measuring the corrosion experienced by an electrical component in a potentially corrosive environment, the method comprising the steps of:
placing at least one resistive element proximate to the electrical component for which corrosion is to be measured;
establishing a voltage differential across the resistive element;
measuring the corrosion-induced resistance of the at least one resistive element; and
relating the measured corrosion-induced resistance to the corrosion experienced by the electrical component.

13. The method of claim 12, wherein the step of establishing a voltage differential across the resistive element further comprises supplying a differential voltage between across the resistive element.

14. The method of claim 12, wherein the step of establishing a voltage differential across the resistive element further comprises supplying a current through the resistive element.

15. The method of claim 12, further comprising the steps of:
providing a first bond pad electrically connected to an anode of the resistive element;
providing a second bond pad electrically connected to a cathode of the resistive element;
isolating the first bond pad and the second bond pad from the corrosive environment; and
establishing a voltage differential between the first bond pad and the second bond pad.

16. The method of claim 15, wherein the step of establishing a voltage differential between the first bond pad and the second bond pad further comprises supplying a differential voltage between the first bond pad and the second bond pad.

17. The method of claim 15, wherein the step of establishing a voltage differential between the first bond pad and the second bond pad further comprises supplying a current through the resistive element.

18. The method of claim 17, wherein the step of supplying a current through the resistive element further comprising supplying a current into the first bond pad and out of the second bond pad.

19. The method of claim 15, wherein the step of isolating the first bond pad and the second bond pad from the corrosive environment further comprising coating the first bond pad and the second bond pad with a protective coating.

20. The method of claim 15, wherein the step of isolating the first bond pad and the second bond pad from the corrosive environment further comprises locating the first bond pad and the second bond out of the corrosive environment.
